(19) United States
(12) Patent Application Publication
(10) Pub. No.: US 2023/0135747 A1
(43) Pub. Date: May 4, 2023

(54) FLUID DELIVERY SYSTEM

(71) Applicant: Droplette Inc., Boston, MA (US)

(72) Inventors: Rebecca Jane Conway, Boston, MA (US); Camden Johnson, Boston, MA (US); Peter Lewis Stokes, Boston, MA (US)

(21) Appl. No.: 17/513,251

(22) Filed: Oct. 28, 2021

(51) Int. Cl. B05B 11/00

(52) U.S. Cl. CPC B05B 11/0054; B05B 11/0008

(57) ABSTRACT

A fluid delivery system includes a housing including cartridge reservoir, a fluid containing cartridge removably receivable in the cartridge reservoir, and a gasket disposed in the cartridge reservoir in a position to engage with the fluid containing cartridge. The gasket includes at least one biasing portion that is flexible in an insertion direction of the fluid containing cartridge when the fluid containing cartridge is received in the cartridge reservoir. The at least one biasing portion of the gasket facilitates air flow from the cartridge reservoir while flexing in the insertion direction.

### BACKGROUND

The present disclosure relates to a fluid delivery system, and more specifically, to for a fluid delivery system that aligns and facilitates fluid release from a cartridge.

Delivery of a fluid containing agent to a localized spot on or within a patient's skin is an important consideration for a variety of skin health treatments, such as localized delivery of antibiotics, the treatment of diabetes, various genetic disorders, cancer treatments, and an expanding number of cosmetic uses. Transdermal delivery is a type of fluid delivery, which specifically refers to delivering an agent by crossing the skin barrier.

Transdermal delivery of antibiotics is preferably used to treat skin and soft tissue infections. Transdermal delivery can deliver large molecules, such as plasmids or vectors, into cells over a localized surface, such as into skin cells. Such localized treatment can be particularly useful where traditional oral and/or intravenous delivery mechanisms are ineffective or inconvenient. Further, in many cases a combination of different delivery devices and methods can be used together to improve delivery results. Using a transdermal delivery approach for localized delivery is superior to hypodermic injection methods, which are painful, risk infection via needle reuse or misuse, and create medical waste.

There are various approaches to transdermal delivery. For example, transdermal patches may be applied directly to the outer layer of the skin, though such approaches only penetrate through the outermost layer of the skin (the stratum corneum), and as such the vast majority of molecules never penetrate deeper than about 10 micrometers beneath the skin surface. Further, because the patches must directly contact the skin surface, there is always a risk of infection from contamination. Other transdermal approaches employ electric currents, ultrasound waves, or chemical transfection reagents. Iontophoresis uses mild electric currents to deliver medications while the target body part is submerged in water. Electroporation applies an electric field to create pores in cell. Chemical transfection reagents (such as Lipofectamine) employ liposomal delivery methods to penetrate the skin surface. Very short microneedles used for transdermal delivery physically pierce the outer layer of skin (the stratum corneum) to enable small molecules that are subsequently applied to cross the skin barrier. Microneedles thus increase skin permeability by creating micron-sized holes in the skin layer to create openings for small molecules to pass through. However, microneedling is painful and generally costly.

### SUMMARY

According to one or more embodiments, a fluid delivery system includes a housing including cartridge reservoir, a fluid containing cartridge removably receivable in the cartridge reservoir, and a gasket disposed in the cartridge reservoir in a position to engage with the fluid containing cartridge. The gasket includes at least one biasing portion that is flexible in an insertion direction of the fluid containing cartridge when the fluid containing cartridge is received in the cartridge reservoir. The at least one biasing portion of the gasket facilitates air flow from the cartridge reservoir while flexing in the insertion direction.

According to other embodiments, a fluid delivery system includes a housing including a cartridge reservoir, a fluid containing cartridge removably receivable in the cartridge reservoir, and a gasket disposed in the cartridge reservoir in a position to engage with the fluid containing cartridge. The gasket includes at least one biasing portion that is flexible in an insertion direction of the fluid containing cartridge when the fluid containing cartridge is received in the cartridge reservoir. The fluid delivery system further includes a fluid releaser disposed at a distal end of the cartridge reservoir. The fluid releaser is positioned in the cartridge reservoir to release a fluid from the fluid containing cartridge when the fluid containing cartridge is received in the cartridge reservoir.

Still yet, according to other embodiments, a fluid delivery system includes a housing including a cartridge reservoir, a fluid containing cartridge removably receivable in the cartridge reservoir, and a fluid releasing assembly disposed at a distal end of the cartridge reservoir. The fluid releasing assembly includes a fluid releaser positioned in the cartridge reservoir to release a fluid from the fluid containing cartridge when the fluid containing cartridge is received in the cartridge reservoir. The fluid releasing assembly further includes a fluid releasing port positioned to receive a fluid from the fluid containing cartridge when said fluid is released from the fluid containing cartridge.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1A is perspective view of a fluid delivery device with an external skin and seated fluid cartridge;

FIG. 1B is a perspective view of the fluid delivery device of FIG. 1A with a partially seated fluid cartridge within the open cartridge door;

FIG. 2A is a perspective view of a fluid delivery device showing the housing;

FIG. 2B is a bottom perspective view of the fluid delivery device of FIG. 1A;

FIG. 3A is a perspective view of a fluid delivery device showing the housing and fluid cartridge;

FIG. 3B is a side view of the fluid delivery device of FIG. 3A with an open cartridge door;

FIG. 3C is a perspective view of the fluid delivery device of FIG. 3A without a fluid cartridge and with an open cartridge door;

FIG. 3D is another perspective view of the fluid delivery device of FIG. 3C with an open cartridge door;

FIG. 4 is an exploded view of a fluid delivery device;

FIG. 5 is an exploded view of the lower housing assembly of a fluid delivery device;

FIG. 6 is a cross-sectional side view of a fluid delivery device;

FIG. 7A is a cross-sectional side view of a fluid delivery device with a partially seated fluid cartridge;

FIG. 7B is a cross-sectional side view of a fluid delivery device with a fully seated fluid cartridge;

FIG. 7C is a cross-sectional side view of a fluid delivery device with a fully seated fluid cartridge showing the cartridge gasket flexing;

FIG. 8A is a top perspective view of a cartridge bucket of a fluid delivery device;

FIG. 8B is a bottom perspective view of the cartridge bucket of FIG. 8A;

FIG. 8C is a partial top view of the cartridge bucket of FIG. 8A;

FIG. 8D is a partial bottom view of the cartridge bucket of FIG. 8A;

FIG. 8E is a side view of the cartridge bucket of FIG. 8A;

FIG. 8F is a front view of the cartridge bucket of FIG. 8A;

FIG. 9 is a perspective view of a cartridge gasket of a fluid delivery device;

FIG. 10A is a perspective view of a cartridge gasket clamp of a fluid delivery device;

FIG. 10B is a back view of a cartridge gasket clamp of FIG. 10A;

FIG. 10C is a bottom view of a cartridge gasket clamp of FIG. 10A;

FIG. 10D is a side view of a cartridge gasket clamp of FIG. 10A;

FIG. 11 is a top view of a piezoelectric transducer of a fluid delivery device; and

FIG. 12 is a partial cross-sectional side view of a fluid delivery device.

### DETAILED DESCRIPTION

While devices and methods exist for fluid delivery (e.g., transdermal delivery) of active agents, they suffer from drawbacks as they irritate the skin, risk infection from direct contact with the skin, and/or are too costly for wide-spread public use. There remains a need for devices and methods for providing local delivery of an agent to tissue in a manner that can be easily administered, are inexpensive, and/or that cause as little skin irritation and pain as possible.

Fluid delivery devices that receive disposable liquid containing cartridges with an active agent and use fluid vaporizers and pumps to produce aerosol mists from the liquid that contain particles of active agents of dimensions that are small enough to pass through a tissue surface provide advantages. For example, such devices are sanitary, as the cartridges are disposable and the device does not directly contact the skin, inexpensive, as they can be used in a home setting, and generally painless and non-irritating.

However, one challenge of such fluid delivery devices includes providing an internal cartridge reservoir for the disposable cartridge that controls fluid flow from the cartridge once fluid is released therefrom to prevent messy and wasteful leakage, while simultaneously allowing air to escape to avoid a build-up of internal pressure which can render the device inoperable. Another challenge is providing a seating mechanism with a fluid releaser or sharp needle that reliably and easily releases liquid from the fluid cartridge, as well as seats the cartridge while allowing fluid to flow from the cartridge without trapping air inside the cartridge.

Accordingly, described herein are fluid delivery methods, systems, and devices that address the above challenges. In some embodiments, a fluid delivery system includes a housing including cartridge reservoir, a fluid containing cartridge removably receivable in the cartridge reservoir, and a gasket disposed in the cartridge reservoir in a position to engage with the fluid containing cartridge. The gasket includes at least one biasing portion that is flexible in an insertion direction of the fluid containing cartridge when the fluid cartridge is received in the cartridge reservoir, and the at least one biasing portion facilitates air flow from the cartridge reservoir while flexing in the insertion direction.

In one or more embodiments, a fluid delivery system includes a housing including a cartridge reservoir, a fluid containing cartridge removably receivable in the cartridge reservoir, and a gasket disposed in the cartridge reservoir in a position to engage with the fluid containing cartridge. The gasket includes at least one biasing portion that is flexible in an insertion direction of the fluid containing cartridge when the fluid cartridge is received in the cartridge reservoir. The fluid delivery system further includes a fluid releaser disposed at a distal end of the cartridge reservoir. The fluid releaser is positioned in the cartridge reservoir to release a liquid fluid from the fluid containing cartridge when the fluid containing cartridge is received in the cartridge reservoir.

In other embodiments, a fluid delivery system includes a housing including a cartridge reservoir, a fluid containing cartridge removably receivable in the cartridge reservoir, and a fluid releasing assembly disposed at a distal end of the cartridge reservoir. The fluid releasing assembly includes a fluid releaser positioned in the cartridge reservoir to release a liquid fluid from the fluid cartridge when the fluid containing cartridge is received in the cartridge reservoir, and a fluid releasing port positioned to receive a liquid fluid from the fluid containing cartridge when said liquid fluid is released from the fluid containing cartridge.

The methods, systems, and devices generate a fluid mist stream that is capable of penetrating into tissue, such as skin, or into cells while minimizing any tissue irritation and/or pain and without the need for direct contact between the device and the tissue or the cells. In one or more embodiments, the methods and devices are used for transdermal fluid delivery, however the methods and devices can be utilized in surgical approaches to apply a fluid to tissue intracorporeally.

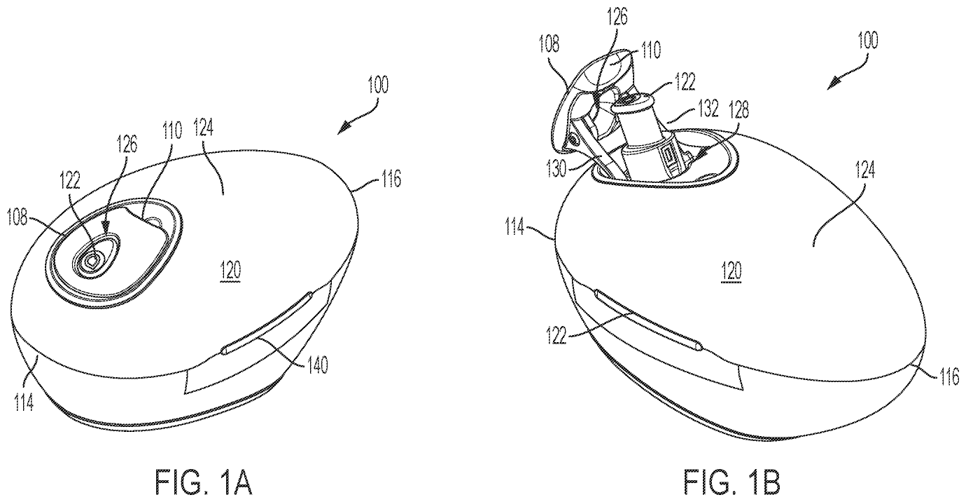

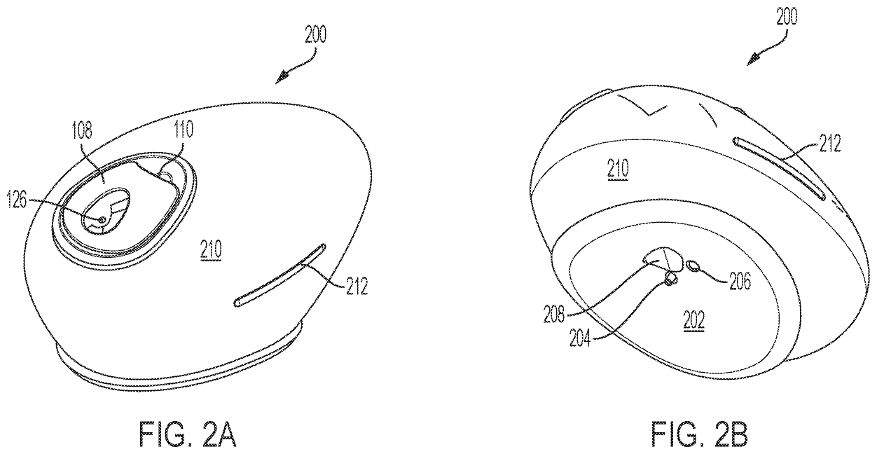

FIG. 1A is perspective view of a fluid delivery device 100 with an external skin 120 and seated fluid cartridge 122. FIG. 1B is a perspective view of the fluid delivery device 100 with the external skin 120 and with a partially seated or received fluid cartridge 122 within the open cartridge door 108. The fluid delivery device 100 is a hand-held device, with a body 124 between a first end 116 and a second end 114. The first end 116 is more tapered than the second end 114 so that the device can be grasped and held to comfortably fit into the palm of a user's hand. The fluid delivery device 100 is generally egg-shaped but is not limited to this shape and can be any shape or dimensions. The opposite or bottom face of the device includes the nozzle (see outlet 208, FIG. 2B) for dispensing the fluid stream onto the tissue (e.g., skin), which is positioned closer towards the second end 114 or wider end of the device. In embodiments, the device includes an external skin 120 that includes include a soft flexible material, such as a silicon material. The external skin 120 includes a trigger cover 140 that covers the device activation trigger in the housing beneath (see FIG. 2A).

A power source is electrically coupled to the circuit board of the fluid delivery device 100. In embodiments, the power source is a replaceable battery with a battery connector. In other embodiments, the power source may be anything that is configured to supply power to the device. For example, the power source may be a rechargeable battery or a cord extending from the end of the fluid delivery device and configured to plug into an outlet or power source. The power source may be replaceable by a user.

The fluid delivery device 100 includes a cartridge door 108 with a viewing aperture 126 for viewing the type of fluid cartridge 122 within. The fluid cartridge 122 is also referred to as a fluid containing cartridge herein. The fluid cartridge 122 (or fluid containing cartridge) is removably receivable in the cartridge reservoir 128 of the fluid delivery device 100. The fluid cartridge 122 may be optionally marked or color coded for simple viewing and identification through the viewing aperture 126 of the cartridge door 108 by a user even when the fluid cartridge 122 is fully seated in the fluid delivery device 100. The cartridge door 108 optionally includes a recess 110 configured for lifting and opening the cartridge door 108. Once opened, the cartridge door 108 extends from a first extendable hinge 130 and a second extendable hinge 132. The fluid cartridge 122 is removably receivable with the cartridge reservoir 128 within the body 124 (or housing 210) of the fluid delivery device.

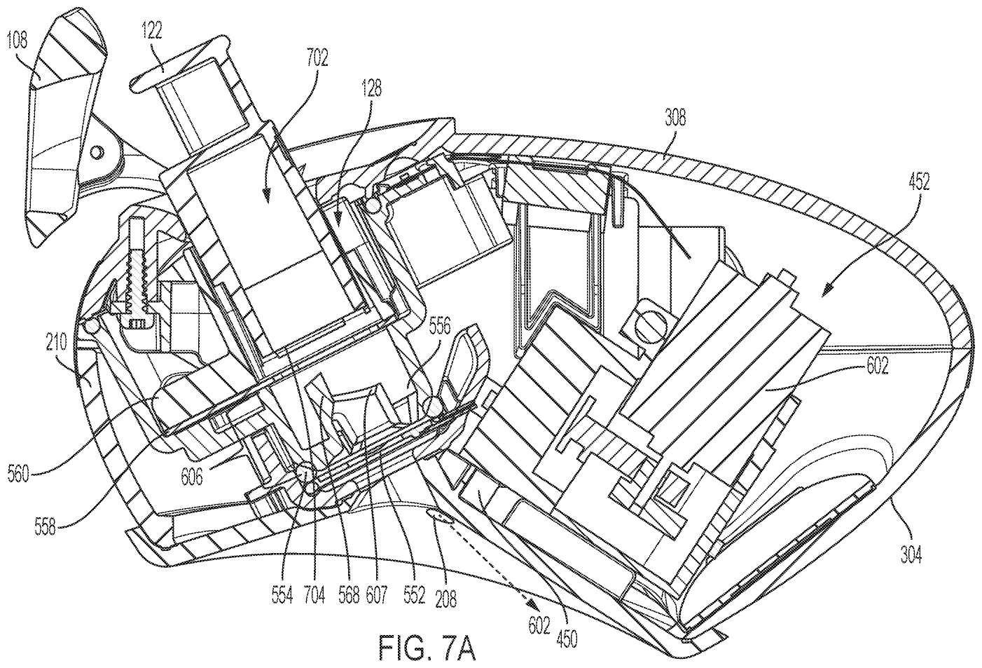

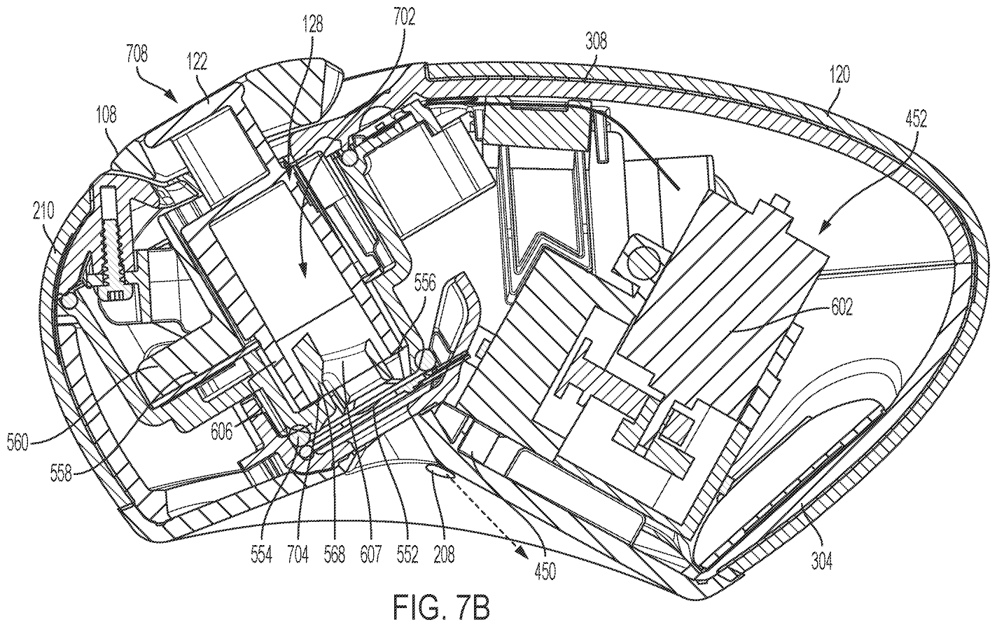

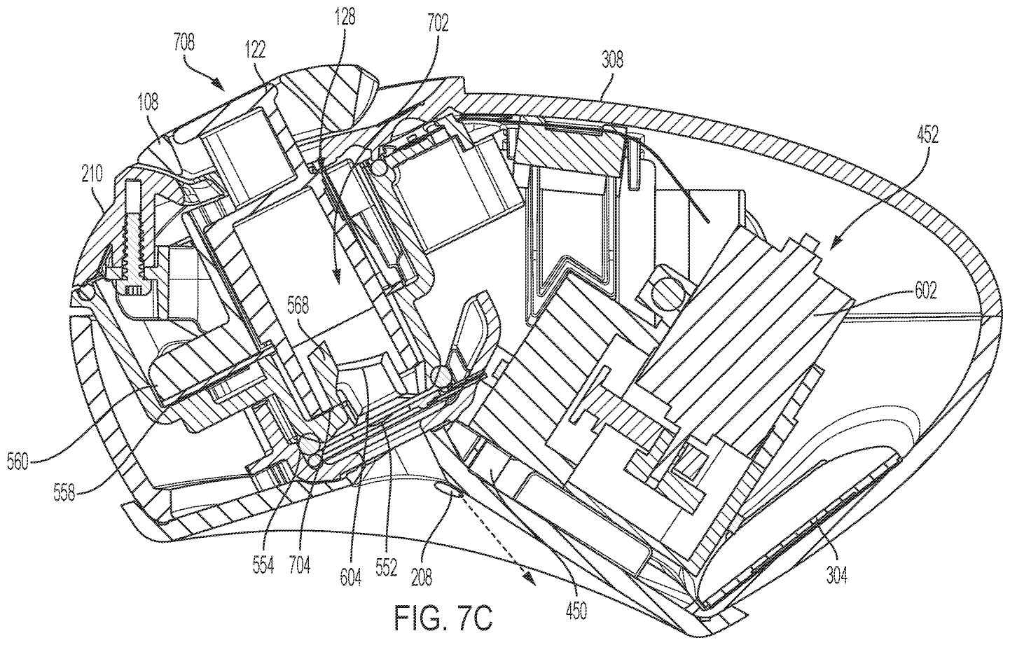

The fluid cartridge 122 includes a fluid cavity 702 (i.e., a liquid, as shown in FIG. 7A) to be introduced into the device and to subsequently flow downstream to the piezoelectric transducer 552, described in further detail below. The fluid cartridge 122 may contain one type of fluid or multiple types of fluid separated by a variety of mechanisms, such as physical barriers or immiscible barriers (for example an oil phase). While the fluid cartridge 122 is illustrated as having a cylindrical shape, any shape capable of retaining fluid can be used, such as a flexible pouch or a cuboidal structure. Additionally, the fluid cartridge 122 can be made of any material capable of retaining fluid, for example rigid or flexible plastic or glass. In the illustrated embodiment, the fluid cartridge 122 also has a sealed port 704 (FIG. 7A) at a distal or downstream end that prevents fluid (e.g., a liquid) flow from the cartridge 122 until insertion into the device. For example, the sealed port 704 can have a rubber, metal (e.g., aluminum), or plastic seal that is punctured or otherwise broken by the releasing structure or fluid releaser 568 upon insertion, which is described in further detail below. Once punctured to release liquid from the fluid cavity 702, the liquid flows directly onto the piezoelectric transducer 552, which turns the liquid to tiny droplets, described in further detail below.

FIG. 2A is a perspective view of the fluid delivery device 200 without an external skin and without a fluid cartridge, and FIG. 2B is a bottom perspective view of the fluid delivery device 200 showing the bottom plate 202 (or skin facing surface). Without the fluid cartridge, the cartridge door 108 with a viewing aperture 126 is closed. The fluid delivery device 200 includes a housing 210 can be made of any rigid material, such as plastic or metal. The bottom face of the device (see FIG. 2B) or the bottom plate 202 of the device is slightly curved, although the shape is not limited to such a curved shape and includes the outlet 208 of the piezoelectric transducer 552. The bottom plate 202 (or skin-facing surface) further includes a pump inlet 450 and a pump outlet 454, which are described below.

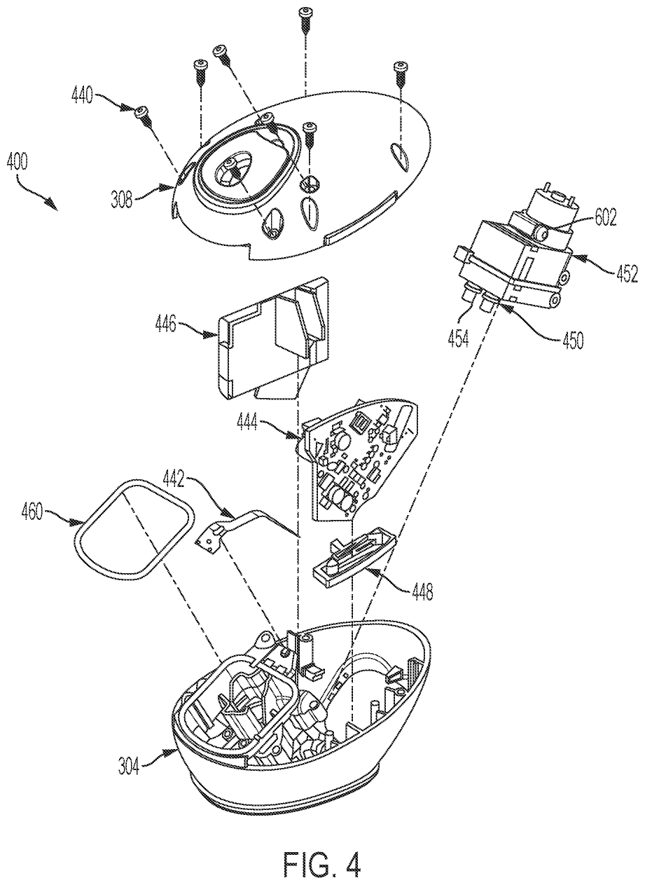

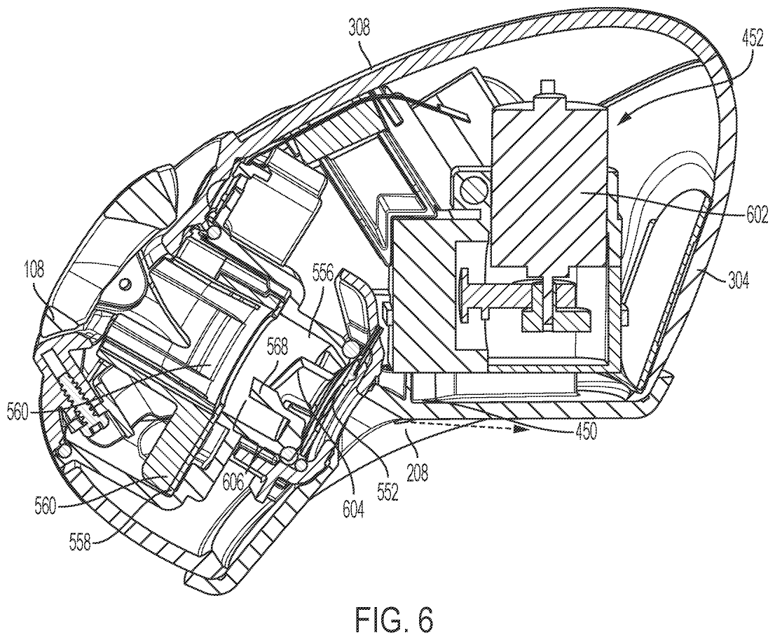

The housing 210 includes an actuator 212 on a side surface approximately half-way between the upper housing and lower housing and in a position that is easily accessible and triggerable by a user's thumb when held in the palm of the hand. However, the actuator 212 can be positioned at any location on the fluid delivery device 100, for example on the upper or lower portions of the housing 210 or on any side surface thereof. Activation of the actuator 212, by depression for example, is effective to activate the pump 602 of the pump assembly 452 (FIGS. 4 and 6) and the piezoelectric transducer 552 within the housing 210, while release of the actuator 212 will terminate activation of the pump 602 of the pump assembly 452 and the piezoelectric transducer 552. In other embodiments, a first depression of the actuator 212 activates the pump 602 and the piezoelectric transducer 552, and a second depression of the actuator 212 terminates activation of the pump 602 and the piezoelectric transducer 552. While the illustrated actuator 212 activates the pump 602 and the piezoelectric transducer 552, one skilled in the art will appreciate that activation of the actuator 212 may cause a variety of different functions and/or processes of the device to activate. For example, activation of the actuator 212 can cause activation of the pump 602 and/or the piezoelectric transducer 552 at selectable pump-speeds and/or frequencies of vibration and voltages, respectively. The illustrated actuator 212 includes a switch electrically coupled to a circuit board 444 within the housing 210 (as seen in FIG. 4). However, the actuator 212 may be any type of switch capable of being electrically coupled to the circuit board 444, such as a dial, a slide, a lever, a knob, a button, a touch screen, or a touch panel. The actuator 212 can also be activated or deactivated by any type of sensor, such as a distance sensor or a pressure sensor that can be automatically activating if the device is within a certain distance or pressed against a barrier (for example a user's skin).

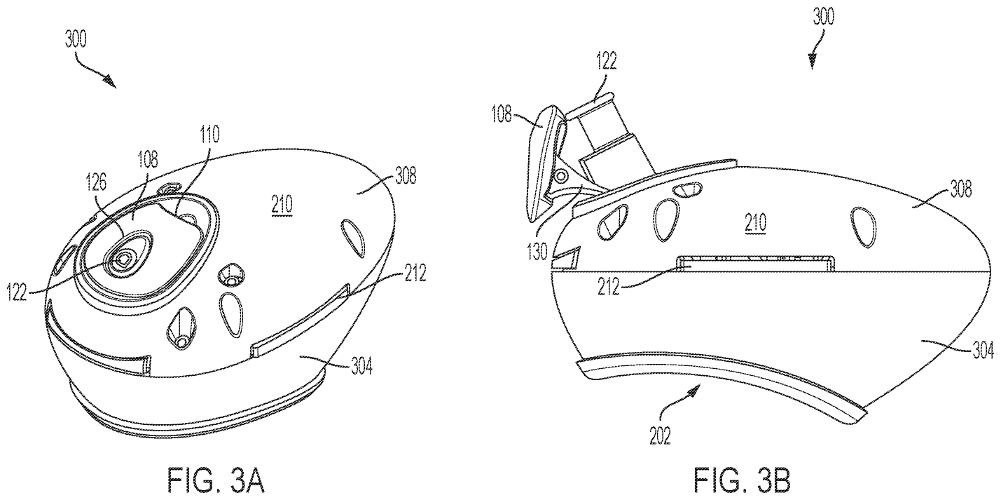

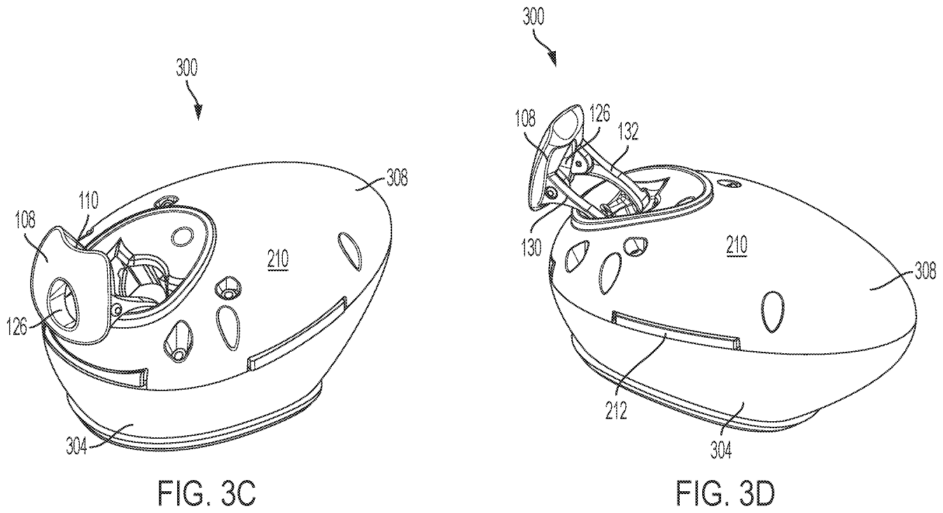

FIG. 3A is a perspective view of a fluid delivery device 300 with a seated fluid cartridge 122 and a closed cartridge door 108, and FIG. 3B is a side view of the fluid delivery device 300 with an open cartridge door 108 and partially seated fluid cartridge 122. FIGS. 3C and 3D are perspective views of the fluid delivery device 300 of FIG. 3B without the fluid cartridge 122. The fluid delivery device 300 includes an upper housing assembly 308 and a lower housing assembly 304, which are described in further detail below.

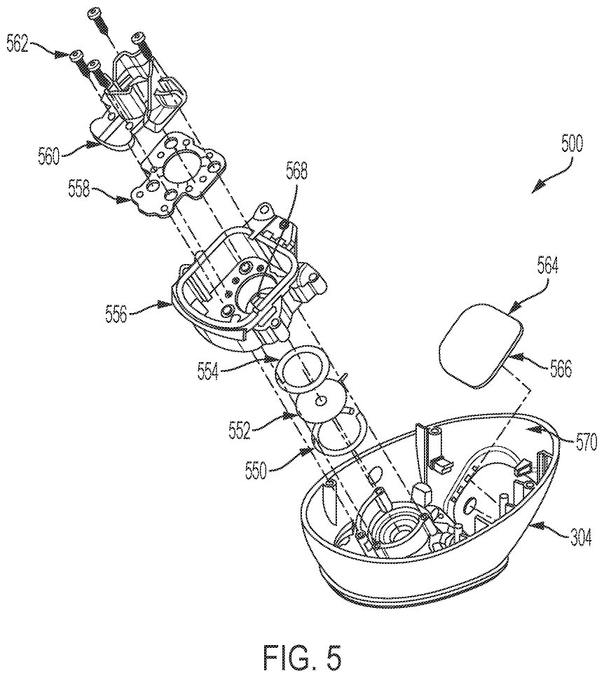

FIG. 4 is an exploded view of a fluid delivery device 400. The fluid delivery device 400 includes a lower housing assembly 304 and an upper housing assembly 308. The upper housing assembly 308 is secured to the lower housing assembly 304 with a plurality of fasteners 440, such as screws. The battery assembly 446 is coupled to the printed circuit board 444 coupled to the chip-LED flex circuit assembly 442. The button actuator 448 forming the actuator 212 is coupled to the printed circuit board 444. A bucket ring 460 is arranged on the cartridge bucket 556 (see FIG. 5).

The pump assembly 452 is placed in the lower housing assembly 304 adjacent to the piezoelectric transducer 552 (see FIG. 5). The pump assembly 452 is in the form of a housing having an inner cavity formed therein. The pump assembly 452 includes a pump inlet 450 and a pump outlet 454 that are in fluid communication with the cavity in the pump assembly 452, and that are positioned to influence the flow of fluid droplets from the piezoelectric transducer 552 (FIG. 5) and the outlet of the lower housing assembly (see outlet 208 in FIG. 2B). In particular, the illustrated pump inlet 450 and pump outlet 454 are positioned a distance apart from one another and have central axes that extend substantially parallel to one another. The pump inlet and pump outlet 450, 454 each extend from the pump into the path of fluid flow exiting from the outlet 208 in the lower housing assembly (see FIGS. 2B and 6). The pump inlet and pump outlet 450, 454 together form an angle that is less than 90° with an axis of the outlet 208, as illustrated in FIG. 6. In various embodiments, the angle between the pump inlet and pump outlet 450, 454 and the axis of the outlet 208 can vary, for example between approximately 60° and approximately 90°, as long as the pump inlet and pump outlet 208 can influence the flow of fluid droplets from the piezoelectric transducer 552 and the outlet 208. An angle between the pump inlet and pump outlet 450, 454 and the axis of the outlet 208 at any of 60°, 65°, 70°, 75°, 80°, 85°, and 90° is contemplated herein.

The configuration of the pump inlet and pump outlet 450, 454 can vary. In the illustrated embodiments, the pump inlet 450 is shaped as a cylindrical channel. In some embodiments, the pump inlet 450 has an inner diameter that is approximately 0.1 millimeters (mm) to approximately 10 centimeters (cm). For example, the diameter can be approximately 1.5 mm. One skilled in the art will appreciate that the pump inlet 450 can be sized and/or shaped in any form necessary to operate with the pump and draw in fluid droplets. The illustrated pump outlet 454 is also shaped as a cylindrical channel, and the pump outlet 454 can likewise have a diameter that varies. In one or more embodiments, the diameter can be approximately 0.1 mm to approximately 10 cm. For example, the diameter can be approximately 1.5 mm. As with the pump inlet 450, the pump outlet 454 may vary in size and/or shape depending on the pump and the amount of fluid to be expelled.

The pump can also have a variety of configurations to facilitate the flow of fluid therethrough. In some embodiments, the pump is a pneumatic diaphragm pump. In use, fluid droplets are accelerated within the pump. Altering a pump speed and/or a pressure can influence the speed and/or size and/or expulsion direction of the fluid droplets. One skilled in the art will appreciate that the pump may be any pump capable of reducing the size of fluid droplets and/or influencing the flow of fluid droplets from the piezoelectric transducer 552 and/or the outlet 208 of the housing, such as a rotary vane pump or a positive displacement pump.

As indicated above, in use the pump expels fluid droplets from the pump outlet 454. The direction and/or force of expulsion of the fluid droplets may be varied, for example by varying the pump speed and/or pump pressure. The fluid droplets will flow back into the spray output flowing from the outlet 208 in the housing, and the fluid spray output will pass through the tissue of the patient or into cells for delivery or transfection of molecules. The fluid may include any fluid with any active agent and molecular weight. The combination of the piezoelectric transducer 552 and the pump assembly 452 are effective to create a mist or stream of fluid having a size that will pass into tissue to a depth of, for example, 1 cm or deeper. As a result, fluid having an active agent with a higher molecular weight can be utilized and will still penetrate into the tissue. In some embodiments, the fluid includes an active agent with a molecular weight of about 500 Daltons or greater. The molecular weight of the active agent in the fluid may also be between about 500 Daltons and about 800 Daltons. The molecular weight may also be greater than 800 Daltons or less than 500 Daltons. After passing through the device, the resulting fluid droplets will be in the sub-micron range and can penetrate through skin pores (approximately 3 micrometers). A velocity and a width of a flow stream of the fluid droplets after expulsion may vary depending on the fluid used and the piezoelectric transducer 552 and the pump 452 and the size of the outlet 208, which can vary from about 0.1 to 5 cm in diameter. But the velocity may be, for example, 0.1 to 0.2 liters/sec, and the width of the spray output may be for example about 1 cm.

The fluid in the fluid containing cartridge is one or more of a liquid, a gas (e.g., air), oil, or a combination thereof.

In some embodiments, the fluid is a medicament used for treating wounds. For example, the fluid can be any antibiotic, for example an antibiotic to treat a skin and soft tissue infection such as ceftaroline. The functionality of the fluid, such as an antibiotic like ceftaroline, can be maintained as the fluid is converted into the fluid droplets and passed through the tissue of the patient. Additionally, while the device can be used for a variety of transdermal delivery purposes, such as to treat skin and soft tissue infections, one skilled in the art will appreciate that fluid may be delivered to internal body tissue, e.g., via open surgical techniques, endoscopic techniques, or laparoscopic techniques. In other embodiments the device can be configured to delivery fluid intranasally. In various embodiments, the fluid can be a vaporized fluid configured for at least one of inhalation, oral delivery, ocular delivery, intra-aural delivery, rectal delivery, and vaginal delivery. The vaporized fluid can be configured for at least one of delivery into ears or eyes. The vaporized fluid can be delivered onto a plate, well, or other surface containing cells and/or cell layers and/or tissue layers and/or plant cell layers for delivery.

The fluid can include a cosmetically acceptable topical carrier. For example, the cosmetically acceptable topical carrier can include an ingredient selected from one or more of the following five classes: wetting agents, emulsifiers, emollients, humectants, and fragrances. In certain embodiments, the cosmetically acceptable topical carrier includes ingredients from two or more of the above-mentioned classes, such as ingredients from at least three or more of such classes. In some embodiments, the cosmetically acceptable topical carrier includes water, an emulsifier, and an emollient. Cosmetically acceptable topical carriers can also be solutions, suspensions, emulsions such as microemulsions and nanoemulsions, gels, solids and liposomes.

In some embodiments, the fluid can include an oil-water emulsion. The fluid can also include at least one of a DNA, protein, virus, phage, bacteria, RNA, mRNA, miRNA, aptamer, stabilized RNA, iRNA, siRNA, and a plasmid. The device and the fluid can also be configured to be used in CRISPR operations and/or applications, such as in gene editing and/or gene delivery.

In other embodiments, the active agent of the fluid is a skin care agent. Non-limiting examples of skin care agents include peeling agents (e.g., hydroxy acids, such as glycolic acid and lactic acid), anti-aging agents (e.g., collagen, hyaluronic acid, and retinoids), abrasives, absorbents, aesthetic components such as fragrances, pigments, colors/dyes, essential oils, skin fresheners, astringents, anti-acne agents, anti-caking agents, anti-foaming agents, antimicrobial agents, antioxidants, binders, biological additives, buffering agents, volumetric agents, chelating agents, chemical additives, dyes, cosmetic astringents, cosmetic biocides, denaturing agents, drug astringents, external analgesics, film-forming or materials, opacity agents, pH adjusters, propellants, reducing agents, sequestrants, bleaching agents and lightening agents of the skin (for example, hydroquinone, kojic acid, ascorbic acid, magnesium ascorbyl phosphate, ascorbyl glucosamine), skin conditioning agents, skin treatment agents, thickeners and vitamins, or any combination thereof.

FIG. 5 is an exploded view of the lower housing assembly of a fluid delivery device 500. The fluid delivery device 500 includes a lower housing assembly 304 with a coil assembly 564 that is part of the inductive (or wireless) charger. The induction coil of the coil assembly 564 is charged when the device/coil is in proximity to a matching charged coil. The piezoelectric transducer 552 is sealed in the lower housing assembly 304 between a lower seal 550 and an upper seal 554, which is an o-ring. The cartridge bucket 556 is coupled to the piezoelectric transducer 552, with the upper seal 554 therebetween. The cartridge gasket 558 is seated in the cartridge bucket 556. A gasket clamp is coupled to the cartridge gasket 558 and secured to the cartridge bucket 556 with fasteners 562, e.g., a plurality of screws.

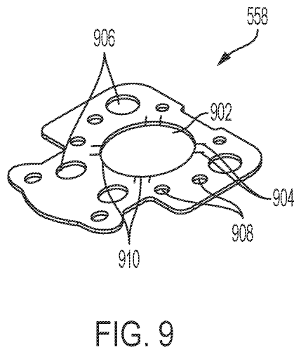

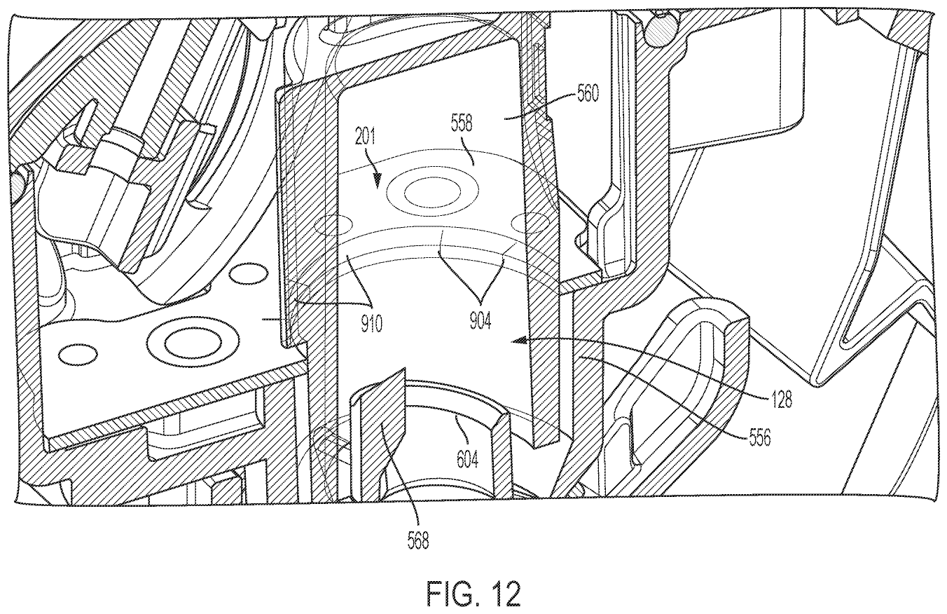

FIG. 7A is a cross-sectional side view of a fluid delivery device with a partially seated fluid cartridge 122, and FIG. 7B is a cross-sectional side view of a fluid delivery device with a fully seated fluid cartridge 122. The cartridge reservoir 128 is in the housing 210 of the device. The fluid cartridge 122 (or fluid containing cartridge) is removably receivable in the cartridge reservoir 128. Once the fluid cartridge 122 is fully engaged in the cartridge reservoir 128, the cartridge door 108 may be closed (FIG. 7B). The cartridge gasket 558 protrudes into an interior of the cartridge reservoir 128 to engage and align the fluid cartridge 122 in the cartridge reservoir 128 (see also, FIG. 12). The cartridge gasket 558 is disposed in the cartridge reservoir 128 in a position to engage with the fluid cartridge 122. The cartridge gasket 558 includes at least one biasing portion that is flexible in an insertion direction 708 of the fluid cartridge 122 when the fluid cartridge 122 is received in the cartridge reservoir 128. The biasing portion of the cartridge gasket 558 that contacts and engages the fluid cartridge 122 provides resistance so that the fluid cartridge 122 does not fall out of the housing 210, even when the cartridge door is open. The cartridge gasket 558 also facilitates air flow when the fluid cartridge 122 is received in the cartridge reservoir 128 and mitigates flow of liquid from the fluid cavity 702 from the fluid cartridge 122. The cartridge gasket 558 allows displaced air to escape from the distal end (downstream end) of the cartridge reservoir 128 as the fluid cartridge 122 is inserted in the cartridge reservoir 128. The displaced air from the cartridge reservoir 128 moves upstream through the cartridge reservoir 128 and through the slits 904 in the cartridge gasket 558 (see FIGS. 9 and 12) and out of the housing 210. The at least one biasing portion of the cartridge gasket 558 facilitates air flow from the cartridge reservoir 128 while flexing in the insertion direction (see FIG. 7C). Flow of fluid (e.g., liquid) from the distal (downstream end) of fluid cartridge 122 is mitigated once the fluid releaser 568 releases liquid from the fluid cartridge 122. Although fluid naturally flows via gravity to the piezoelectric transducer 552, if the fluid delivery device is inverted, liquid from the fluid cartridge 122 may flow upstream and out of the device, which would be wasteful and messy. The cartridge gasket 558 provides a barrier that mitigates such undesired upstream liquid flow.

The piezoelectric transducer 552 is located downstream of the fluid cartridge 122 and upstream of the outlet 208 in the housing 210. The piezoelectric transducer 552 is in fluid communication with the liquid that flows from the fluid cavity 702 of the fluid cartridge 122 once punctured by the fluid releaser 568 such that liquid from the fluid cavity 702 from the fluid cartridge flows to the piezoelectric transducer 552 by gravitational forces or by any other method capable of causing fluid flow, such as through use of a pump, capillary action, electromagnetic forces, vacuum suction, electrophoresis, a wick, or electro-osmotic flow. Upon contact, the piezoelectric transducer 552 is configured to cause the liquid to separate into fluid droplets in the form of an aerosol mist of liquid particles. The fluid droplets may collide with and separate from one another within the piezoelectric transducer 552, further reducing droplet size. Upon expulsion from the piezoelectric transducer 552, the fluid droplets will flow in a transitional flow regime (between laminar and turbulent flow) or a turbulent flow regime that may cause rapid droplet coalescence and/or further droplet breakup, depending on a variety of factors such as the liquid, any exit conditions, a direction of spray, and the frequency of vibration with which the liquid droplets are generated in the piezoelectric transducer 552. A laminar flow regime is a flow regime characterized by flows in parallel layers with no disruption between the layers, and a turbulent flow regime is a flow regime characterized by chaotic property changes. While the device is described in connection with a piezoelectric transducer 552, one skilled in the art will appreciate that any component may be used that is configured to cause separation of the fluid into droplets to create an aerosol mist, such as a metal, ceramic, or conductive diaphragm.

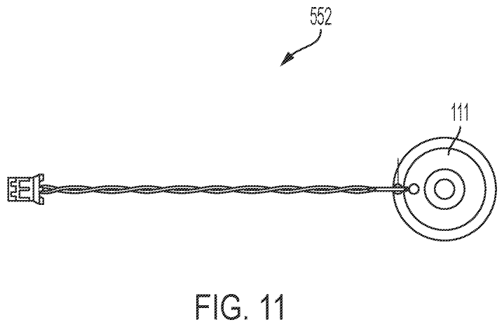

The piezoelectric transducer 552 is provided downstream from the cartridge reservoir 128 and fluid cartridge 122 and upstream from the outlet 208. The piezoelectric transducer 552 is coupled to the cartridge reservoir 128 by an upper seal 554. The piezoelectric transducer 552 has a piezo plate 111, shown in more detail in FIG. 11, that is capable of being vibrated and/or oscillated at ultrasonic frequencies to drive the separation of the liquid into droplets and to produce an aerosol mist of liquid particles from the liquid. The piezoelectric transducer 552 can be manufactured, for example, by Homidics. However other transducers can be used.

The piezoelectric transducer 552 is electrically coupled to the printed circuit board 444 (see FIG. 4) and may be activated upon activation of the actuator 212 (see FIG. 3B). A frequency of vibration of the piezo plate 111 may be varied to cause greater separation or less separation of the liquid, as well as the flow rate. The frequency of vibration of the piezo plate 111 can vary between 1 kHz and 10 mHz, for example. A voltage applied to the piezoelectric transducer 552 may also be varied. While the voltage can vary depending on the piezoelectric transducer 552, the voltage may be between −30 and 30 V, for example. The frequency of vibration and/or voltage may be varied manually or automatically.

The piezoelectric transducer 552 expels fluid droplets from the piezo plate 111 and through the outlet 208. A volume of streams of the liquid droplets generated by the piezoelectric transducer 552 will vary depending on the fluid and the piezoelectric transducer. For example, the streams may be microstreams with volumes ranging from approximately 1 microliters (μl) to approximately 10 milliliters (ml).

Upon expulsion from the housing 210, the liquid droplets may interact with a pump 602 or a similar component that provides the ability to pressurize and/or break up the fluid droplets by putting the droplets into a transitional flow regime or into a turbulent flow regime. The pump 602 can be placed within the housing 210 of the device as shown. However, the pump 602 may be placed anywhere as long as it can interact with the liquid droplets. The pump 602 has a pump inlet 450 and a pump outlet 454 (see FIG. 4). The pump 602 inlet may be positioned to interact with the liquid flowing from the outlet 208 in the housing 210. The pump inlet 450 may draw the fluid droplets into the pump 602. An amount of the liquid in a range of about 10-90% of the liquid can be drawn into the pump 602, and the force of the pump 602 can accelerate the aerosol that is not drawn into it directly via the exhaust stream. The liquid droplets can be accelerated through a pumping action of the pump 602 and/or an exhaust stream of the pump 602. The pump 602 can further increase acceleration and reduce the size of the liquid droplets by, for example, drawing droplets through the fluid path of the pump 602 and by, for example, exhaust of the pump. For example, the liquid droplets within the pump 602 can be accelerated to a greater speed and may continue to collide with one another, further reducing droplet size. The pump 602 can then expel the fluid droplets through the pump outlet 454. The pump outlet 454 can be positioned such that the expelled fluid droplets from the pump 602 interact with the fluid droplets expelled from the outlet 208 of the housing 210. The two expelled fluid droplet streams can influence, collide, cross, interact, and/or disrupt each other. This interaction can cause the liquid droplets to further reduce in size and give them more velocity. This interaction can also generate a transitional flow that has properties of both a laminar flow and a turbulent flow. The liquid droplets can accelerate away from the pump 602 and impact tissue of a user or a membrane of a cell. This impact can also further reduce droplet size. As a result, the liquid droplets are capable of passing through the tissue, such as skin. The liquid droplets can retain their native function as they pass through the tissue, thus administering the functional liquid droplets deep within a patient's tissue. Using both the piezoelectric transducer 552 and the pump 602 in combination can allow the liquid droplets to be significantly reduced in size, for example by a factor of about 10 or more, and accelerated at a high speed as the liquid droplets impact the tissue.

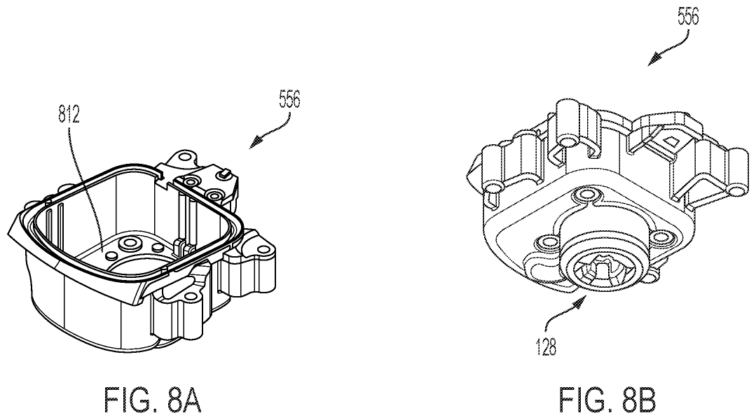

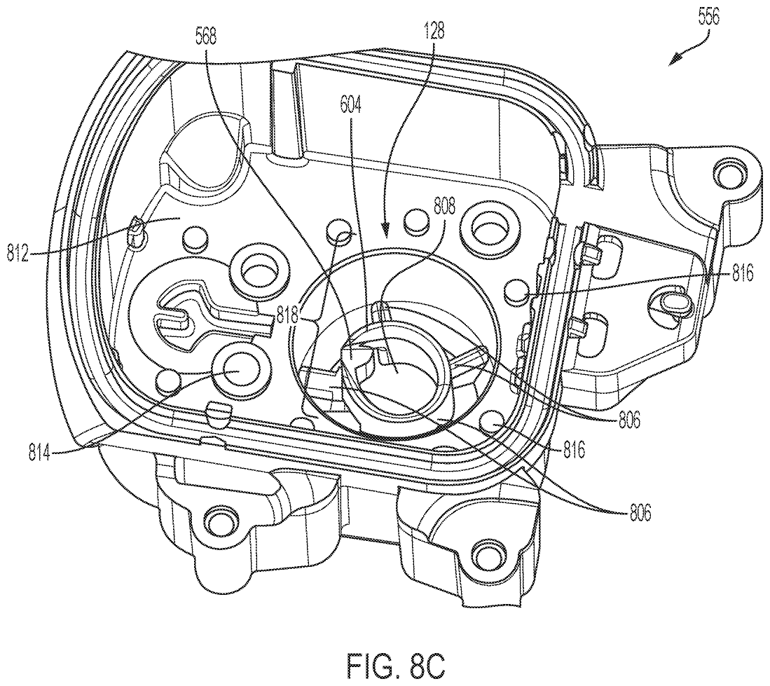

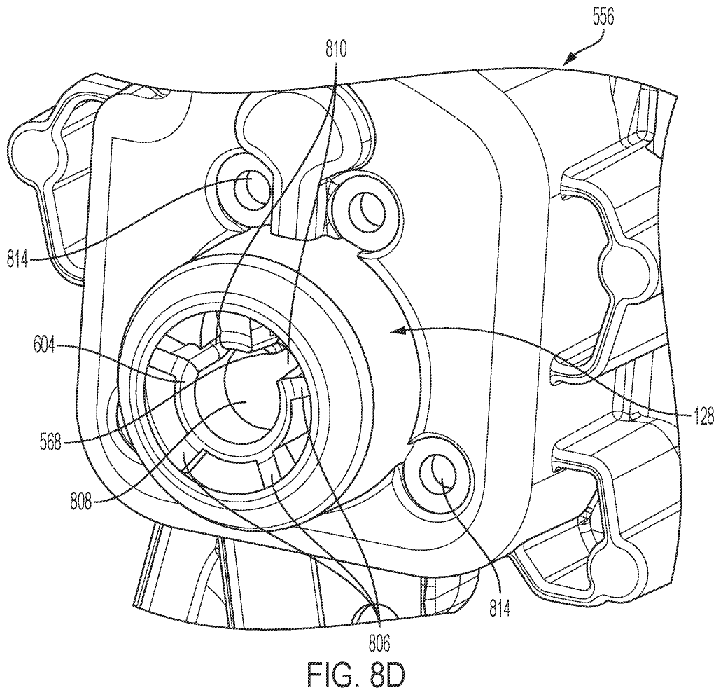

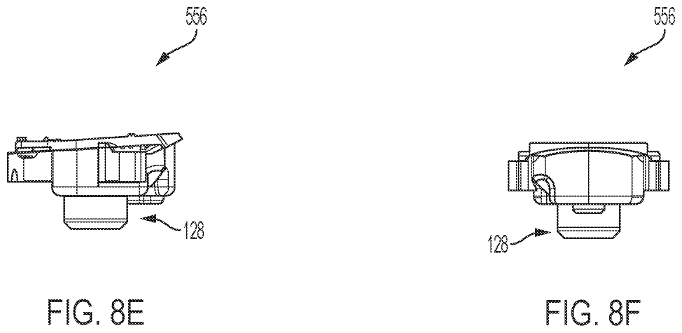

FIGS. 8A-8E show various views of the cartridge bucket 556 (also referred to as a gasket bucket) of a fluid delivery device. The cartridge bucket 556 includes a gasket seating surface 812 where the cartridge gasket 558 is seated and housed. The cartridge bucket 556 optionally includes a plurality of fastener openings 814 for securing the cartridge bucket 556 to the cartridge gasket 558, cartridge gasket clamp 560 and lower housing assembly 304. The cartridge bucket 556 includes a cavity 818 that forms the bottom, downstream portion (also referred to as first portion or distal portion or end) of the cartridge reservoir 128.

As is briefly discussed above, the cavity 818 includes the fluid releaser 568 located at a distal (downstream) end of the cartridge reservoir 128, which would be located beneath the cartridge gasket 558 when seated on the gasket seating surface 812. The fluid releaser 568 is configured to puncture a sealed port 704 of the fluid cartridge 122 to release the liquid from the fluid cavity 702 of the fluid cartridge 122. The fluid releaser 568 extends from a first surface (upstream surface) of a cylinder 604 with a diameter less than a diameter of the cartridge reservoir 128. According to one or more embodiments, the fluid releaser 568 includes a sharp needle or piercer that is positioned in the cartridge reservoir 128 to release a fluid from the fluid cartridge 122 when the fluid cartridge 122 is received in the cartridge reservoir 128.

The cylinder 604 includes a plurality of spokes 806 that extend from a second surface of the cylinder (see FIG. 8D) opposite the first surface and to an inside surface of the cartridge reservoir 128. The plurality of spokes 806 are configured to be a seating surface for the fluid cartridge 122 when fully engaged in the cartridge reservoir 128. While the cylinder 604 shown includes 5 spokes, the cylinder 604 may include any number of spokes 806. For example, the cylinder 604 includes at least 2, at least 3, at least 4, at least 5, at least 6, at least 7, at least 8, at least 9, or at least 10 spokes. In some embodiments, the cylinder 604 includes about 3 to about 7 spokes 806. In other embodiments, the cylinder 604 includes about 4 to about 6 spokes 806. The second surface of the cylinder 604 includes at least one cavity 810 between two spokes 806, which is configured to reduce surface tension and facilitate fluid flow from the liquid the fluid cavity 702 of the fluid cartridge 122 once engaged in the cartridge reservoir 128. In embodiments, the cylinder 604 includes two cavities 810, or more than two cavities 810.

In some embodiments, the fluid releaser 568 is part of a fluid releasing assembly 606 disposed at a distal end of the cartridge reservoir 128. The fluid releasing assembly 606 includes a fluid releaser 568 positioned in the cartridge reservoir 128 to release a fluid from the fluid cartridge 122 when the fluid cartridge 122 is received in the cartridge reservoir 128. The fluid releasing assembly 606 further includes a fluid releasing port positioned to receive a fluid from the fluid containing cartridge 122 when said fluid is released from the fluid cartridge 122. In some embodiments, the fluid releaser 568 and the fluid releasing port (e.g., the cylinder 604) are of unitary construction with each other. In embodiments, the fluid releasing port is the cylinder 604. The fluid releasing port is positioned to receive a fluid from the fluid cartridge 122 via gravity. The fluid releaser 568 extends from a perimetric wall of the fluid releasing port (e.g., cylinder 604). In some embodiments, the fluid releasing port includes at least one cut out in at least one wall defining the fluid releasing port (see cavity 810 in cylinder 604).

FIG. 9 is a perspective view of a cartridge gasket 558 of the fluid delivery device. The cartridge gasket 558 is formed of a flexible material, such as a polymeric material. In one or more embodiments, the polymeric material is a rubber, such as ethylene propylene diene monomer (EPDM) rubber, a polysiloxane (silicone), or a combination thereof. The cartridge gasket 558 is formed of a flexible material that flexes, bends, or deforms in the direction of insertion of the fluid cartridge 122 and returns to its resting, non-flexed, non-bent, or non-deformed state when the fluid cartridge is removed (see FIG. 7C).

The cartridge gasket 558 includes an opening 902 that is surrounded by a plurality of slits 904, forming a plurality of petals 910 between the slits 904. The cartridge gasket shown includes 8 slits 904 as shown but does not require 8 slits. In one or more embodiments, the cartridge gasket 558 includes at least 1 slit 904, which forms 2 petals 910. In other embodiments, the cartridge gasket 558 includes at least 2 slits, at least 3 slits, at least 4 slits, at least 5 slits, at least 6 slits, at least 8 slits, at least 9 slits, at least 10 slits, or more than 10 slits. In some embodiments, the cartridge gasket 558 includes about 1 to about 20 slits 904. In other embodiments, the cartridge gasket 558 includes about 5 to about 15 slits. The cartridge gasket 558 further, optionally, includes a plurality of openings 908 through which fasteners, e.g., screws, can be used to secure the cartridge gasket 558 to the cartridge bucket 556.

When seated in the cartridge bucket 556, a portion of the cartridge gasket 558 protrudes into an interior of the cartridge reservoir (see FIG. 12). The portion that protrudes into the interior of the cartridge reservoir 128 includes the one or more slits 904. When a fluid cartridge 122 is engaged in the cartridge reservoir 128, the cartridge gasket 558 applies a radial pressure to the fluid cartridge (see FIGS. 7B and 12). The gasket is configured to engage and align the fluid cartridge 122 in the cartridge reservoir 128. The gasket flexes in an insertion direction (or downstream direction 201) of the fluid cartridge 122 when the fluid cartridge 122 is engaged in the cartridge reservoir 128 (see FIG. 12).

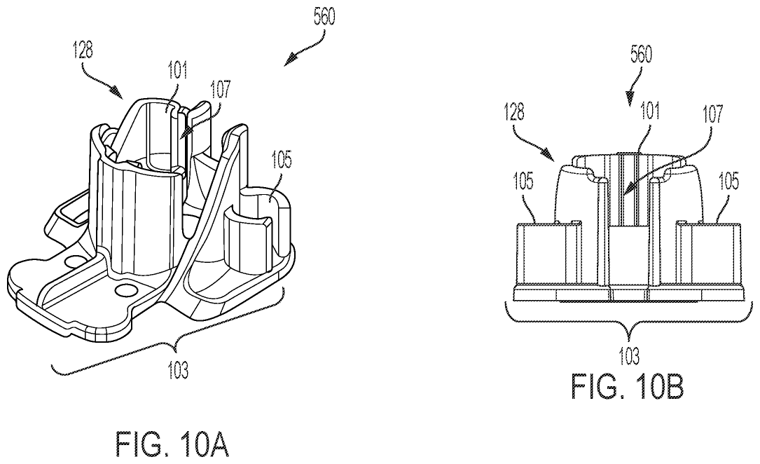

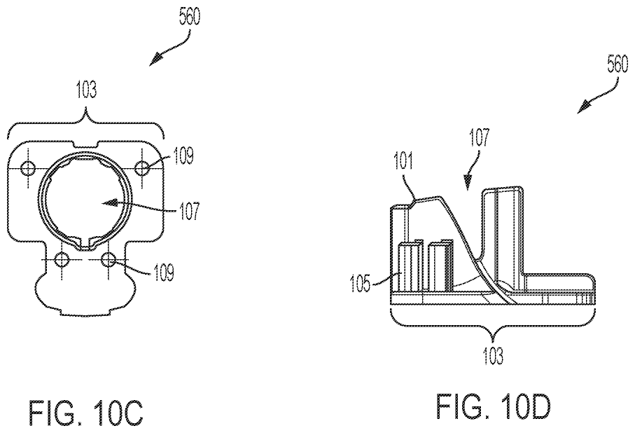

FIGS. 10A-10D show various views of a cartridge gasket clamp 560 of a fluid delivery device. The cartridge gasket clamp 560 is coupled to the cartridge gasket 558 (see FIG. 7A). The bottom surface 103 has a shape that is substantially the same as the cartridge gasket 558. In other embodiments, the bottom surface 103 of the cartridge gasket claim 560 has a shape that is different than the cartridge gasket 558. The cartridge gasket clamp 560 includes walls 101 that extend from the bottom surface 103 that surround a cavity 107 that forms a second portion (an upstream portion) of the cartridge reservoir 128. When combined, the cartridge bucket 556 and the cartridge gasket clamp 560, with the cartridge gasket 558 therebetween, form the cavity that forms the cartridge reservoir 128. The cartridge gasket clamp 560 further includes fastener alignment seats 105 and openings 109 therein, through which fasteners (e.g., screws) can be used to couple or secure the cartridge gasket clamp 560 to the cartridge gasket 558 and the cartridge bucket 556.

According to one or more embodiments, a method of making a fluid delivery device includes arranging a gasket in a cartridge reservoir of a housing. The cartridge reservoir is formed by coupling the cartridge basket to the cartridge clamp, with the cartridge gasket therebetween, and arranging the gasket in the cartridge reservoir includes disposing the gasket in a gasket bucket to house the gasket, and the gasket bucket includes a cavity that forms a first portion of the cartridge reservoir. Arranging the gasket in the cartridge reservoir further includes positioning a gasket clamp on the gasket once disposed in the gasket bucket, and the gasket clamp includes a cavity that forms a second portion of the cartridge reservoir. The gasket protrudes into an interior of the cartridge reservoir and is configured to engage and align a fluid cartridge in the cartridge reservoir. The gasket is further configured to flex in an insertion direction of the fluid cartridge when the fluid cartridge is engaged in the cartridge reservoir. The gasket facilitates air flow and mitigates liquid flow when the fluid cartridge is in engaged in the cartridge reservoir.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

While the preferred embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. A fluid delivery system comprising:
a housing including cartridge reservoir;
a fluid containing cartridge removably receivable in the cartridge reservoir; and
a gasket disposed in the cartridge reservoir in a position to engage with the fluid containing cartridge, the gasket including at least one biasing portion that is flexible in an insertion direction of the fluid containing cartridge when the fluid containing cartridge is received in the cartridge reservoir;
wherein the at least one biasing portion of the gasket facilitates air flow from the cartridge reservoir while flexing in the insertion direction.

2. The fluid delivery system of claim 1, wherein the gasket mitigates liquid flow from the fluid containing cartridge.

3. The fluid delivery system of claim 1, wherein the gasket comprises at least one slit in a portion that protrudes into the interior of the cartridge reservoir.

4. The fluid delivery system of claim 1, wherein the gasket comprises at least two slits in a portion that protrudes into the interior of the cartridge reservoir.

5. The fluid delivery system of claim 1, wherein the gasket applies a radial pressure to the fluid containing cartridge.

6. The fluid delivery system of claim 1, wherein the gasket comprises a polymeric material.

7. The fluid delivery system of claim 1, further comprising a gasket bucket that houses the gasket and includes a cavity that forms a first portion of the cartridge reservoir.

8. The fluid delivery system of claim 7, further comprising a gasket clamp on the gasket that includes another cavity that forms a second portion of the cartridge reservoir.

9. A fluid delivery system comprising:
a housing including a cartridge reservoir;
a fluid containing cartridge removably receivable in the cartridge reservoir;
a gasket disposed in the cartridge reservoir in a position to engage with the fluid containing cartridge, the gasket including at least one biasing portion that is flexible in an insertion direction of the fluid containing cartridge when the fluid containing cartridge is received in the cartridge reservoir; and
a fluid releaser disposed at a distal end of the cartridge reservoir, the fluid releaser being positioned in the cartridge reservoir to release a fluid from the fluid containing cartridge when the fluid containing cartridge is received in the cartridge reservoir.

10. The fluid delivery system of claim 9, wherein the gasket mitigates liquid flow from the fluid containing cartridge.

11. The fluid delivery system of claim 9, wherein the fluid releaser extends from a first surface of a cylinder with a diameter less than a diameter of the cartridge reservoir.

12. The fluid delivery system of claim 11, wherein the cylinder further comprises a plurality of spokes that extend from a second surface of the cylinder opposite the first surface and to an inside surface of the cartridge reservoir, the plurality of spokes configured to be a seating surface for the fluid containing cartridge.

13. The fluid delivery system of claim 12, wherein the second surface of the cylinder includes at least one cavity between two spokes, the at least one cavity configured to reduce surface tension and facilitate fluid flow from the fluid containing cartridge.

14. The fluid delivery system of claim 13, wherein the at least one cavity is positioned to receive the liquid from the fluid containing cartridge via gravity.

15. The fluid delivery system of claim 12, wherein the gasket is housed in a gasket bucket that includes a cavity that forms a first portion of the cartridge reservoir with the plurality of spokes that is configured to form the seating surface.

16. The fluid delivery system of claim 15, further comprising a gasket clamp on the gasket that includes another cavity that forms a second portion of the cartridge reservoir.

17. The fluid delivery system of claim 9, wherein the gasket comprises at least one slit in a portion that protrudes into the interior of the cartridge reservoir.

18. The fluid delivery system of claim 9, wherein the gasket comprises at least two slits in a portion that protrudes into the interior of the cartridge reservoir.

19. The fluid delivery system of claim 9, wherein the gasket comprises a polymeric material.

20. The fluid delivery system of claim 9, wherein the gasket applies a radial pressure to the fluid containing cartridge.

21. A fluid delivery system comprising:
a housing including a cartridge reservoir;
a fluid containing cartridge removably receivable in the cartridge reservoir; and
a fluid releasing assembly disposed at a distal end of the cartridge reservoir, the fluid releasing assembly including:
a fluid releaser positioned in the cartridge reservoir to release a fluid from the fluid containing cartridge when the fluid containing cartridge is received in the cartridge reservoir; and
a fluid releasing port positioned to receive a fluid from the fluid containing cartridge when said fluid is released from the fluid containing cartridge.

22. The fluid delivery system of claim 21, wherein the fluid releasing port is positioned to receive the fluid from the fluid containing cartridge via gravity.

23. The fluid delivery system of claim 21, wherein the fluid releaser and the fluid releasing port are of unitary construction with each other.

24. The fluid delivery system of claim 21, wherein the fluid releaser extends from a perimetric wall of the fluid releasing port.

25. The fluid delivery system of claim 21, wherein the fluid releasing port is a cylinder.

26. The fluid delivery system of claim 21, wherein the fluid releasing port includes at least one cut out in at least one wall defining the fluid releasing port.
